(19) United States
(12) Patent Application Publication
(10) Pub. No.: US 2012/0324504 A1
(43) Pub. Date: Dec. 20, 2012

(54) SYSTEMS AND METHODS FOR PROVIDING PARENTAL CONTROLS IN A CLOUD-BASED MEDIA GUIDANCE APPLICATION

(75) Inventors: Kuan Hidalgo Archer, Marina Del Rey, CA (US); Lloyd Dakin, Fremont, CA (US); Sam Hui, Belmont, CA (US); Neel Suhas Ketkar, Santa Monica, CA (US); Walter R. Klappert, Los Angeles, CA (US); Bo Hye Lee, Sherman Oaks, CA (US); Sean Charles Penn, Santa Rosa, CA (US); Ben Ziskind, San Marcos, CA (US); Bin Zhao, Hangzhou (CN)

(73) Assignee: UNITED VIDEO PROPERTIES, INC., Santa Clara, CA (US)

(21) Appl. No.: 13/341,346

(22) Filed: Dec. 30, 2011

Related U.S. Application Data
(60) Provisional application No. 61/497,043, filed on Jun. 14, 2011.

(51) Int. Cl. H04N 21/266

(52) U.S. Cl. 725/30; 725/25

(57) ABSTRACT

Systems and methods for providing parental controls in a cloud-based media guidance application may provide users with compiled listings of the user's content and parental controls for accessing that and other content based on the user equipment devices from which the content access request is received. A user may identify remote storage providers at which user content is stored, and may provide criteria for limiting or preauthorizing access to selected content by one or more user equipment devices. In response to receiving a user request, a listing of content stored with the remote storage providers may be compiled and presented in a media guidance application. A selection of any one of the user's content, as well as a selection of any other content listed in the media guidance application, may be subject to access control criteria applicable to the user equipment device from which the selection was received.

### CROSS REFERENCE TO RELATED APPLICATION

This claims the benefit of U.S. Provisional Application No. 61/497,043, filed Jun. 14, 2011, the entire disclosure of which is incorporated by reference herein.

### BACKGROUND OF THE INVENTION

Due to an overwhelming volume of content (e.g., video and audio) available to an average person from sources, such as, for example, the Internet, radio, and cable and satellite television, interactive media guidance applications have gained widespread popularity. Interactive guidance applications typically present content listings in a guide display having various selectable options for accessing that content.

Users also may have their own content stored with a plurality of remote storage providers. To view listings of their content, users typically may have to access each remote storage provider separately, and may have to view a separate content listing from each remote storage provider. Viewing separate content listings in this way may be time consuming, cumbersome, and inconvenient.

Furthermore, while some known interactive media guidance applications offer parental controls, these parental controls are typically not configurable beyond selecting a channel or a program to be blocked.

### SUMMARY OF THE INVENTION

In view of the foregoing, systems and methods for providing parental controls in a cloud-based media guidance application are provided. In particular, an interactive media guidance application is provided that allows a user to identify the one or more remote storage providers at which the user's content is stored. The media guidance application may allow the user to view a compiled listing of all of the user's content stored with the identified remote storage providers. For example, a user may have his or her own favorite movies stored with one remote storage provider, electronic books stored with another remote storage provider, and favorite TV shows stored with a third remote storage provider. After having identified those remote storage providers to the media guidance application, and in response to receiving a user request, the media guidance application may compile a list of all of the user's content stored with the remote storage providers. This list may be displayed to the user in a content listings display. In response to receiving a user selection of content from the list, the media guidance application may initiate a data transfer with the appropriate remote storage provider to retrieve the selected content.

Additionally or alternatively, the media guidance application allows the user to control access to content available via the media guidance application. This access control may be applicable to not just a type of content (e.g., content with violence or rated for mature audiences), but to specific user equipment devices from which requests to access content are received by the media guidance application. For example, a user may have several user equipment devices, such as, for example, the user's own smart phone, a home television, and several laptop computers and portable media players. Each device is capable of accessing the media guidance application and content presented therein. The user's children may use some of the laptop computers and portable media players and have access to the home television, while the user has exclusive use of his smart phone and a laptop computer. In response to receiving instructions from the user, the media guidance application may block access by certain user devices, such as, for example, those devices used by the user's children, to certain types of content or content from certain sources, that may include, for example, any of the user's remote storage providers. The media guidance application may be instructed by the user to require user access authorization from certain devices before allowing access to certain types of content or content from certain sources. For example, the media guidance application may require user access authorization when certain content is requested from a home television that may be used by the user and/or the user's children. Thus, the user may still able to view any and all content desired by entering the appropriate user access authorization, while the user's children may be prevented from accessing certain types of content or content from certain sources. Additionally or alternatively, the media guidance application may be instructed by the user to preauthorize certain devices, such as, for example, the user's smart phone and laptop, to access any and all content from any source. The user is therefore not inconvenienced by having to enter access authorization each time the user desires to view content from his or her exclusively used devices.

### BRIEF DESCRIPTION OF THE DRAWINGS

The above and other advantages of the invention will be apparent upon consideration of the following detailed description, taken in conjunction with the accompanying drawings, in which like reference characters refer to like parts throughout, and in which:

FIGS. 1-2 show illustrative display screens that may be used to provide media guidance application listings in accordance with some embodiments of the invention;

FIG. 3 shows an illustrative user equipment device in accordance with some embodiments of the invention;

FIG. 4 is a diagram of an illustrative cross-platform interactive media system in accordance with some embodiments of the invention.

FIG. 5 is a diagram of an illustrative media guidance application system coupled to cloud-based remote storage providers in accordance with some embodiments of the invention;

FIGS. 6-8 show illustrative display screens that may be used to retrieve content from cloud-based remote storage providers in accordance with some embodiments of the invention;

FIGS. 9-15 show an illustrative sequence of illustrative display screens for controlling access to content in accordance with a some embodiments of the invention;

FIG. 16 illustrates a flow diagram for providing access controls in a cloud-based media guidance application in accordance with some embodiments of the invention;

FIG. 17 shows an illustrative XML file for access control information in accordance with some embodiments of the invention; and

FIG. 18 illustrates a flow diagram for providing access controls in a cloud-based media guidance application in accordance with some embodiments of the invention.

### DETAILED DESCRIPTION OF EMBODIMENTS

The invention generally relates to parental controls in a cloud-based media guidance application. In particular, systems and methods are provided to present to a user a listing of content, including a user's own content stored with one or more remote storage providers, and to control access to content based on the particular user equipment device from which a request to access content is received.

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content. As referred to herein, the term “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, Web sites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, Web sites, and any other type of guidance data that is helpful for a user to navigate among and locate desired content selections.

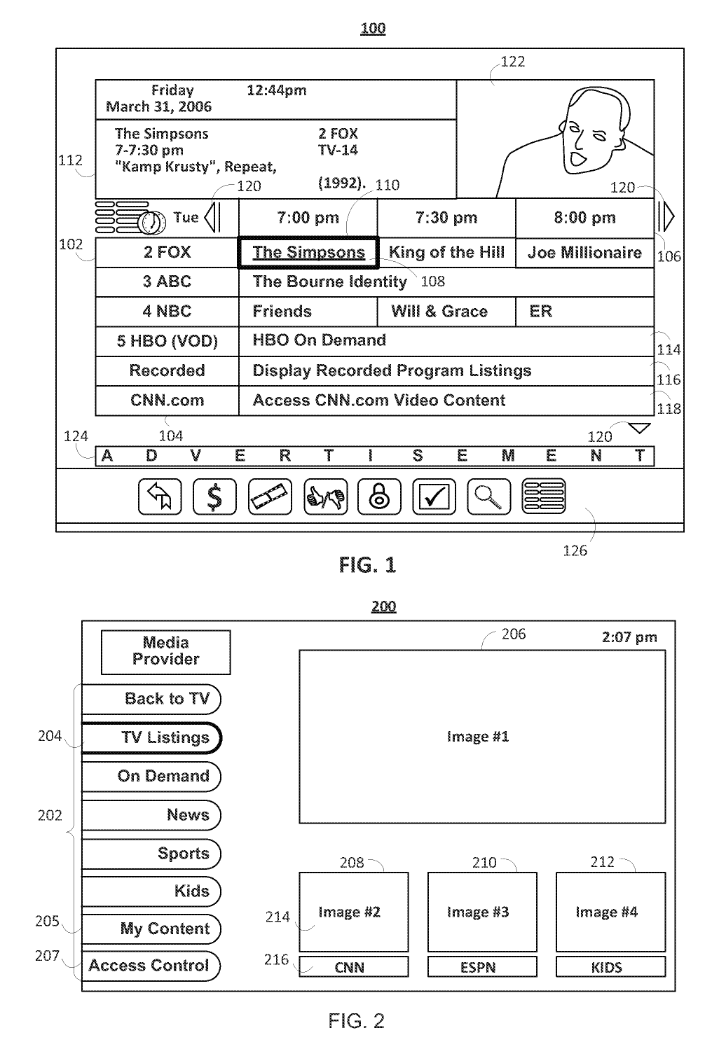

FIGS. 1-2 show illustrative display screens that may be used to provide media guidance data. The display screens shown in FIGS. 1-2 may be implemented on any suitable user equipment device or platform. While the displays of FIGS. 1-2 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet Web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental or access control options (as described in detail below), Internet options, cloud-based options (e.g., with respect to a user's own content stored with one or more remote storage providers, as described in detail below), device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental or access control settings (as described in detail below), customized presentation of Internet content (e.g., presentation of social media content, e-mail, electronically delivered articles, etc.) and other desired customizations. For example, a user may customize the appearance and arrangement of items in a display screen presenting a compiled listing of a user's own content stored with a plurality of remote storage providers. The user may additionally customize the appearance and arrangement of items in a display screen presenting parental control access settings applicable to user equipment devices from which the user's content, as well as other content, may be accessed.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other Web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. Selectable options 202 may also include a “MY CONTENT” option for accessing a user's own content stored with one or more remote storage providers, as shown in FIG. 2 and described in detail below. Selectable options 202 may further include a parental or access control option for controlling access to certain types of content by certain user equipment devices, as also shown in FIG. 2 and described in detail below. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

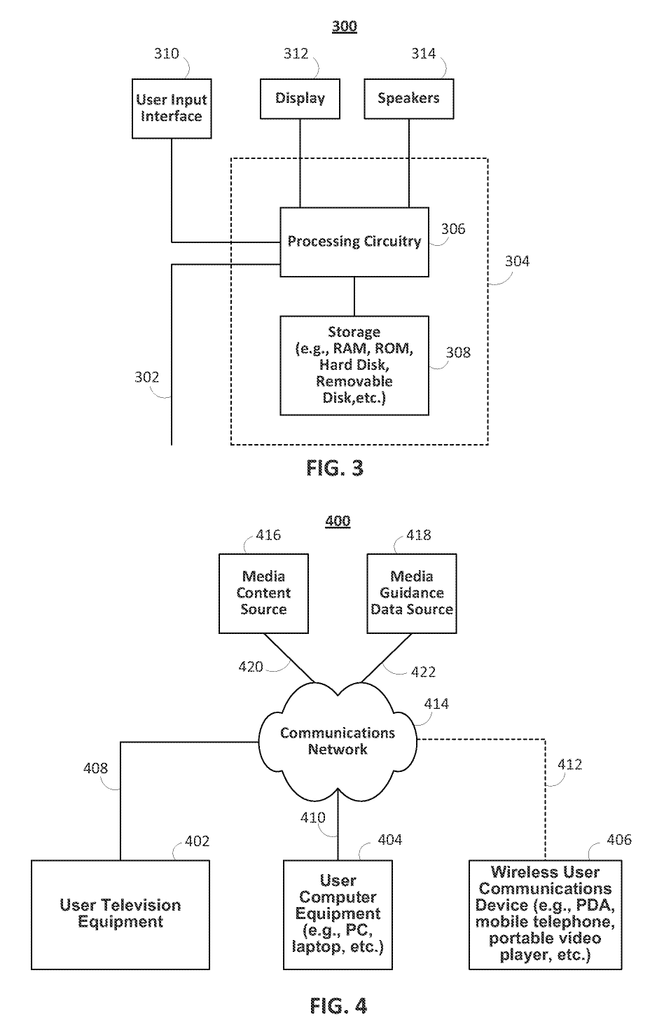

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308).

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a Web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the Web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the ABC, INC., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, a remote storage provider allowing users to store personal content, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and a server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes describe above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a Web site via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or, a user device can download content from multiple cloud resources for more efficient downloading. In some embodiments, user equipment devices can use cloud resources for processing operations such as the processing operations performed by processing circuitry described in relation to FIG. 3.

In some embodiments, a plurality of cloud-based remote storage providers, sometimes referred to as digital vaults, may be coupled via a communication path to a media guidance application system, such as system 400.

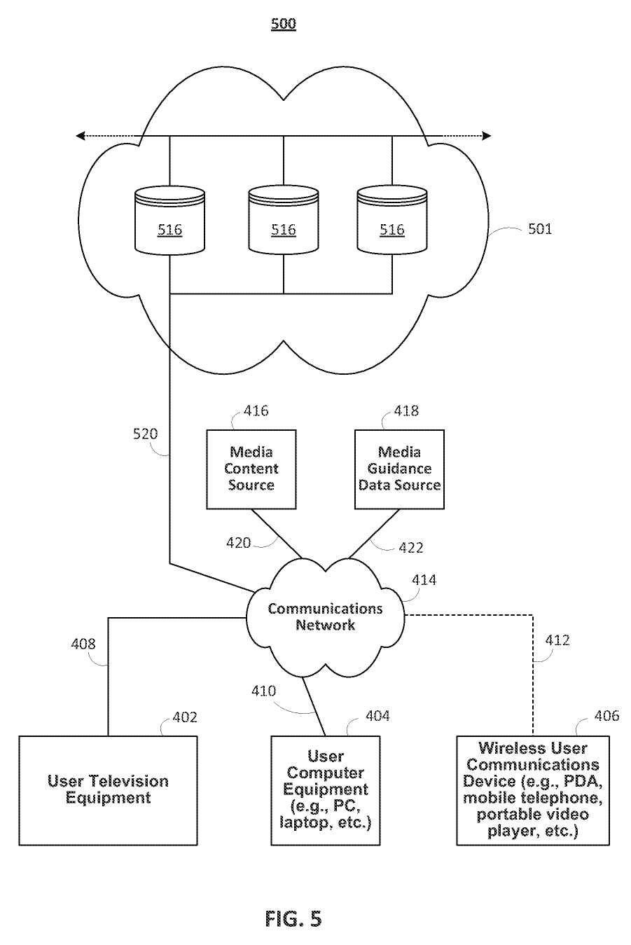

An example of such an arrangement is shown in FIG. 5 as media guidance application system 500. As illustrated, system 500 may include a media content source, a media guidance data source, a communications network, user television equipment, user computer equipment, and wireless user communication device(s). These components may be similar to or the same as components 416, 418, 414, 402, 404, and 406, respectively, as illustrated in, and described in connection with, FIG. 4.

System 500 may also include a cloud 501 of remote storage providers 516 and a communication path 520. Remote storage providers 516 may be any suitable equipment and/or services used to provide content storage services to users. Users may store any suitable content, such as, for example, movies, TV shows, home videos, music, games, electronic books, photographs, text files, other video and/or audio recordings, etc. with these providers, and different or the same types of content may be stored with different providers. For example, in some embodiments, users may store with one provider certain types of content, while storing with another provider other types of content. For example, a user may store his/her favorite movies and TV shows with one remote storage provider, his/her photographs and home videos with another storage provider, and his/her music and other audio recordings with a third storage provider.

In some embodiments, remote storage providers 516 may include providers of services that offer, for example, social networking and purchase or rental of on-demand video, on-demand audio, and/or application software. For example, a social networking service may allow users to share various types of content, such as photographs and videos. In another example, one or more remote storage providers may offer a subscription-based video-on-demand service where videos may be purchased and/or rented (e.g., for a 48 hour period) and then streamed or downloaded to the user's equipment device 300. In a third example, one or more remote storage providers may offer music and/or music videos for purchase that may be downloaded to the user's equipment device 300. In another example, users may purchase and download application software that may be for their user equipment devices 300, such as, for example, a ring tone for their mobile phone and/or a bank deposit application for their smart phone. Some examples of these remote storage providers may include FACEBOOK, NETFLIX, iTUNES STORE, APP STORE, and AMAZON INSTANT VIDEO. FACEBOOK is a service mark owned by Facebook, Inc. NETFLIX is a service mark owned by Netflix, Inc., and APP STORE and iTUNES STORE are service marks owned by Apple, Inc. AMAZON INSTANT VIDEO is operated by Amazon Digital Services, Inc. One or more of the remote storage providers in system 500 may be independently accessible by a user. For example, a user may access a remote storage provider by directly accessing a Web site associated with the remote storage provider. Although only three remote storage providers 516 are shown in FIG. 5 to avoid overcomplicating the drawing, any suitable number of remote storage providers may be provided within cloud 501.

Communication path 520 may be any suitable communication path and may include, for example, any of the communication paths described above in connection with paths 408, 410, 412, 420, and 422 (FIG. 4), and/or may be part of communications network 414. Any other communications path(s) suitable for communicating with cloud resources may additionally or alternatively be used in some embodiments. Although shown in FIG. 5 as outside cloud 501, components of media guidance application system 500 may be a part of the cloud. For example, media content source 416, media data source 418, and/or a server application of the media guidance application may be a part of cloud 501.

In some embodiments, media guidance application system 500 may provide a user with a single point of access to the user's content stored with one or more remote storage providers 516 and/or to content available via services provided by one or more remote storage providers 516. In doing so, system 500 may display on a user equipment display 312 a compiled listing of that content from the one or more remote storage providers. The single point of access may enable the user to access one or more remote storage providers with a single menu selection instead of having to possibly access each remote storage provider separately.

A request to access the user's content may be made by selecting, for example, MY CONTENT option 205 in selectable options 202 of display 200 (FIG. 2). The MY CONTENT option, or any other suitable option, may additionally or alternatively be available in, for example, options region 126 of display 100 and/or any other suitable display. In some embodiments, access to user content stored with one or more remote storage providers may be requested by pressing a dedicated or assignable button on user input interface 310.

In some embodiments, prior to being able to access content provided by and/or content stored with providers 516, a user may need to configure system 500 to access the providers. Any suitable configuration mechanism can be provided. In some embodiments, a remote storage provider 516 may configure system 500 in any suitable fashion to free users from having to do so.

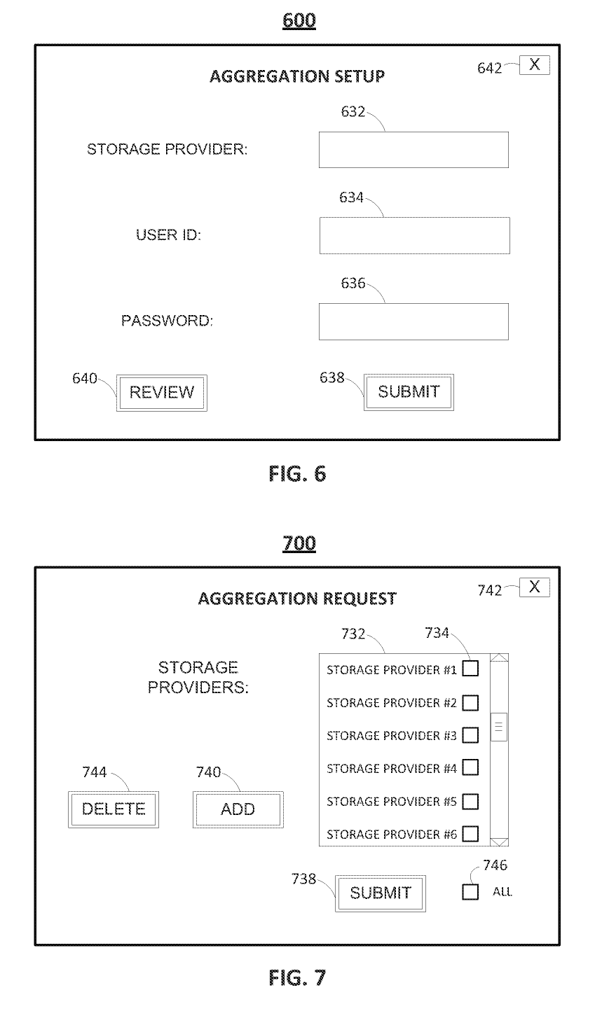

FIG. 6 illustrates an example of a setup display screen 600 that may be presented by control circuitry 304 to enable a user to configure system 500 to access providers 516. Screen 600 may be accessible by the user from any suitable menu option. In some embodiments, screen 600 may additionally or alternatively be presented in response to a first-time request by a user to access the user's content stored with, or content provided by, one or more remote storage providers.

As shown in FIG. 6, setup display screen 600 may enable a user to enter login information (e.g., user ID and password) for one or more remote storage providers 516 at which the user would like to access content via system 500. For example, in some embodiments, display screen 600 may include a field 632 for identifying a remote storage provider. A remote storage provider 516 may be identified in any suitable manner. For example, the user may identify a remote storage provider by providing a Web site address, by providing a name, etc., for the remote storage provider in field 632. Any other suitable identification usable by control circuitry 304 for locating, contacting, and/or establishing communication with a remote storage provider 516 may be entered. In some embodiments, field 632 may instead be a drop down menu that may present a selectable list of remote storage providers with which control circuitry 304 may have pre-established communications.

In fields 634 and 636 of FIG. 6, a user may next enter his or her user ID and password, respectively, for the storage provider identified in field 632. Upon completing entries in fields 632, 634, and 636, the user may actuate a SUBMIT button 638 to transmit that information to control circuitry 304. In response to receipt of the login information, control circuitry 304 may store the information in storage 308 and/or transmit the information for storage at a media guidance data source 418 or other suitable resource. In some embodiments, control circuitry 304 may store the login information in the user's profile. The user's profile may be stored in storage 308, media guidance data source 418, and/or any other suitable location. The user may repeat this process for other remote storage providers. A user may review the submitted entries by actuating a REVIEW button 640, and may exit setup screen 600 by actuating an EXIT icon 642.

Setup screen 600 may be presented as overlaying a portion of a displayed screen (e.g., display 100 (FIG. 1) or 200 (FIG. 2), a television broadcast display, etc.) that is already displayed or may appear full screen. In some embodiments, screen 600 may include other display areas and/or features, such as, for example, an information area, a video display, an advertisement region, and/or an options region similar to, for example, information area 112, video display 122, advertisement region 124, and/or options region 126, respectively, of display 100 of FIG. 1.

FIG. 7 illustrates an example of a display screen 700 that may be presented by control circuitry 304 to enable a user to request a listing of content. Display screen 700 may include display region 732, which may display a list of the remote storage providers previously submitted by the user.

In some embodiments, screen 700 may be used to add or delete remote storage providers from the list in region 732. To add additional remote storage providers to the list, the user may actuate an ADD button 740, which may cause control circuitry 304 to display setup display screen 600. To delete a remote storage provider from the list, the user may check a box 734 displayed to right of that storage provider and actuate a DELETE button 744. Control circuitry 304 may respond by instructing the user to confirm the deletion request before removing the selected storage provider from the list.

Control circuitry 304 may cause screen 700 to be presented as overlaying a portion of a displayed screen (e.g., display 100 (FIG. 1) or 200 (FIG. 2), a television broadcast display, etc.) that is already displayed or may appear full screen. In some embodiments, display screen 700 may include other display areas and/or features, such as, for example, an information area, a video display, an advertisement region, and/or an options region similar to, for example, information area 112, video display 122, advertisement region 124, and/or options region 126, respectively, of display 100.

To request a listing of user content from one or more of the listed remote storage providers, the user may check a box 734 for each storage provider to be included, or if all are to be included, the user may check ALL box 746, and then select a SUBMIT button 738. Control circuitry 304 may then transmit to each remote storage provider selected in the list in region 732 a request (which may include the user's login information) for access to the user's stored content. These requests may include requests for the names of files and folders accessed at the remote storage provider and any annotations and/or metadata associated with the user's stored content.

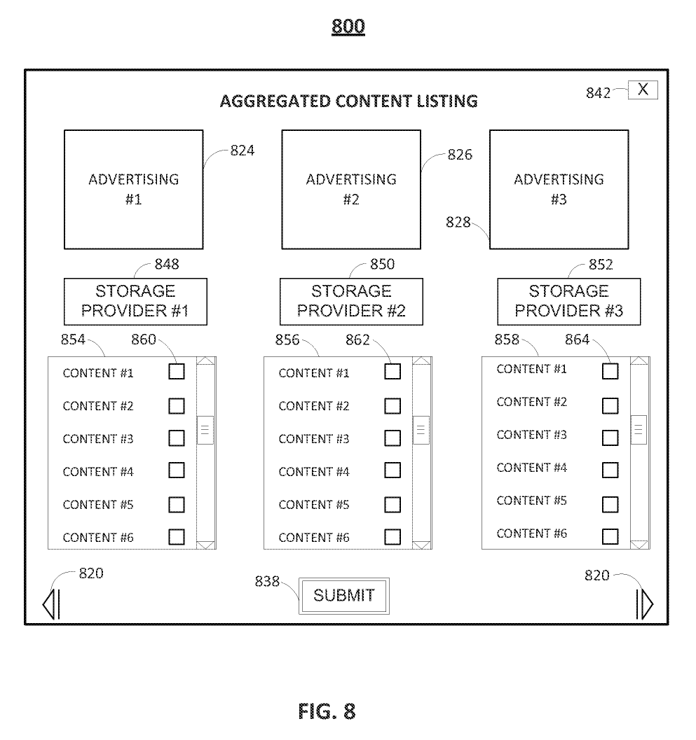

In response to receiving the requested information from each of the remote storage providers, control circuitry 304 may compile a listing of the user's content from the received information and generate an aggregated user content listing display screen 800, illustrated in FIG. 8. Display screen 800 may include content source identifier regions 848, 850, and 852, which identify the remote storage providers at which the content listed in content list regions 854, 856, and 858, respectively, are stored. In cases where there are more remote storage provider content lists than may be displayed on display 800, control circuitry 304 may present in display 800, and respond to actuations of, navigational icons 820 to allow a user to scroll to those other lists. In some embodiments, the content lists in regions 854, 856, and 858 may be presented by control circuitry 304 in a full screen display.

A user may select content for viewing or downloading by, for example, checking appropriate box 860, 862, or 864 next to the desired content and actuating a SUBMIT button 838. As described above in connection with FIGS. 1 and 2, display 800 may include other ways of selecting content from list regions 854, 856, and 858. For example, control circuitry 304 may provide a scrollable highlight region, similar to region 110 of display 100, to be used in conjunction with user input interface 310 for selecting desired content.

In response to receiving a user content selection, control circuitry 304 may issue a request to the appropriate storage provider 516 to retrieve the selected content.

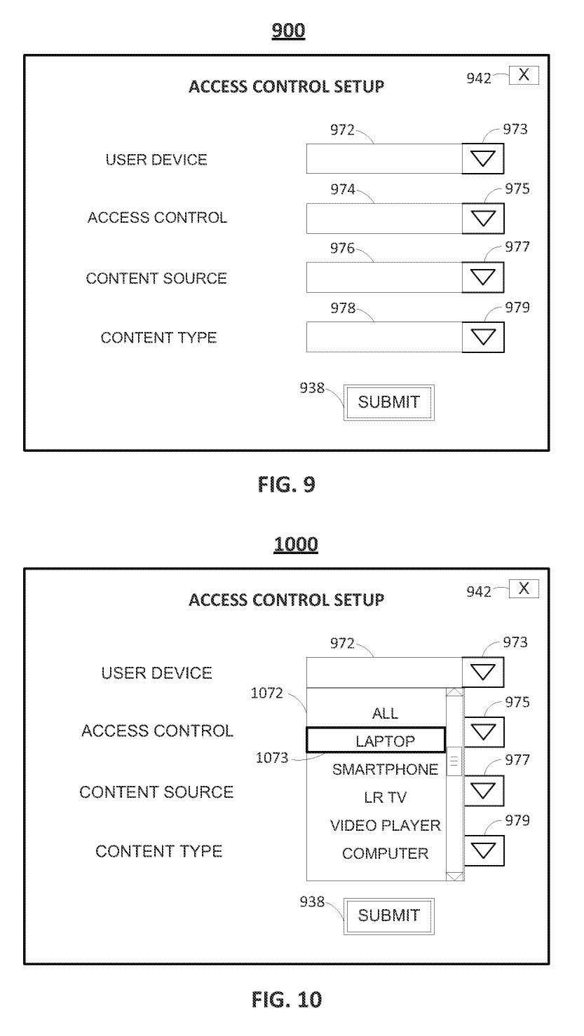

In response to receiving the selected content, control circuitry 304 may cause the selected content to be displayed on display 312 in any suitable manner, as described above in connection with FIGS. 3 and 4. In some embodiments, the retrieval and display of selected content may be subject to parental controls, as described further below in connection with FIGS. 9-17.

Display screen 800 may also include advertising regions 824, 826, and 828. These advertising regions may be used by control circuitry 304 to display advertising received from the remote storage providers. For example, advertising region 824 may display advertising received from STORAGE PROVIDER #1, advertising region 826 may display advertising received from STORAGE PROVIDER #2, and advertising region 828 may display advertising received from STORAGE PROVIDER #3. The displayed advertising may be promoting the remote storage providers themselves, or the displayed advertising may be advertisements that the remote storage providers have been paid to display.

Advertising data for use in populating one or more of advertising regions 824, 826, and 828 may be received by control circuitry 304 from one or more remote storage providers along with requested information regarding a user's content stored with that remote storage provider. Control circuitry 304 may then use the advertising data to generate an advertising display in an appropriate advertising region 824, 826, or 828 to be presented in screen 800 on display 312. The displayed advertising may have hyperlinks to an advertisers' Web site, a remote storage providers' Web site, or any other suitable Web site. After displaying on a display 312 advertising received from, for example, a remote storage provider, control circuitry 304 may transmit an acknowledgement to that remote storage provider indicating that the received advertising is being presented on a display of a user equipment device. In some embodiments, any one or all of advertising regions 824, 826, and 828 may display advertising from any suitable source(s).

In some embodiments, control circuitry 304 may generate advertising for one or more advertising regions 824, 826, and 828. Advertising generated by control circuitry 304 may be based on one or more of a user's selections of, for example, content from one or more remote storage providers 516. For example, if the user rented an action movie from a first provider, and purchased a fantasy television program from a second provider, control circuitry 304 may generate advertising for services and/or products related to a combination of both the action movie and fantasy television program, such as, for example, advertising directed to science fiction content. In order to generate such advertising, control circuitry 304 may retrieve and use information regarding the use of remote storage providers by the user from a user's profile in some embodiments. In some embodiments, advertising generated by control circuitry 304 may be based on services and/or products available from one of the remote storage providers 516. Control circuitry 304 may alternatively or additionally generate advertising based on, for example, current theatrical releases and/or current television programming, news, sporting events, and/or public events. Advertising generated by control circuitry 304 may be based on any suitable content, sponsor(s), event(s), remote storage provider(s), and/or source(s).

In some embodiments, access controls may be provided that allow users to control the content accessed by different user equipment devices. As described above in connection with FIG. 4, user equipment devices may include one or more of user television equipment 402, user computer equipment 404, and/or wireless user communications devices 406. For example, a user and his or her family may have a smart phone, several home televisions, several laptop computers, and several mobile video players that are capable of accessing the media guidance application and content presented therein. Because the user's children may use or have access to several of these devices, the user may want to limit the types of content accessible by those devices, while still allowing unfettered access to any type of content with other devices. For example, the children may use their own laptop computers and portable media players, while the user may have exclusive use of his or her smart phone and laptop computer. System 400 may allow a user to indicate which devices are preauthorized, which require access authorization, and/or which should be blocked from accessing certain types of content or content from certain sources.

FIG. 9 illustrates an example of an access control setup screen 900 in accordance with some embodiments of the invention. Control circuitry 304 may generate and transmit to display 312 access control setup display screen 900 in response to a user selecting an access control option and entering an access control code (e.g., a password or personal identification number (“PIN”)). The control code may be entered by the user with user input interface 310, which may be, for example, a remote control. The access control option may be available in, for example, options region 126 of display 100 or selectable options 202 of display 200, such as, for example, ACCESS CONTROL 207 (FIG. 2), or may be actuated by pressing a dedicated or assignable button on user input interface 310.

As shown in FIG. 9, display screen 900 may include four list regions 972, 974, 976, and 978 for selecting access control parameters such as a user device, the level of access control, the content source(s) to which the controls apply, and the type of content to which the controls apply, respectively. Any other suitable regions and any other suitable access control parameters may be provided in some embodiments.

In response to a user actuating list icon 973 in list region 972, control circuitry 304 may cause drop down menu region 1072 to be displayed with a listing of the user's equipment devices, as shown in FIG. 10. This listing may be retrieved by control circuitry 304 from storage 308 or from media guidance data source 418. When from media guidance data source 418, source 418 may generate a list of user equipment devices based on each device's initial access of the media guidance application under the user's account. Alternatively, any suitable method of generating a list of a user's equipment devices may be used. In some embodiments, the list of user equipment devices in menu region 1072 may include an option of ALL, which may allow a user to apply the same access controls to all of the user's equipment devices. A user may select a particular device by scrolling a highlight indicator 1073 over a desired device with user input interface 310 and then actuating an appropriate key or button associated with user input interface 310. As indicated in FIG. 10, for example, the user may select a laptop computer to which access controls are to be applied.

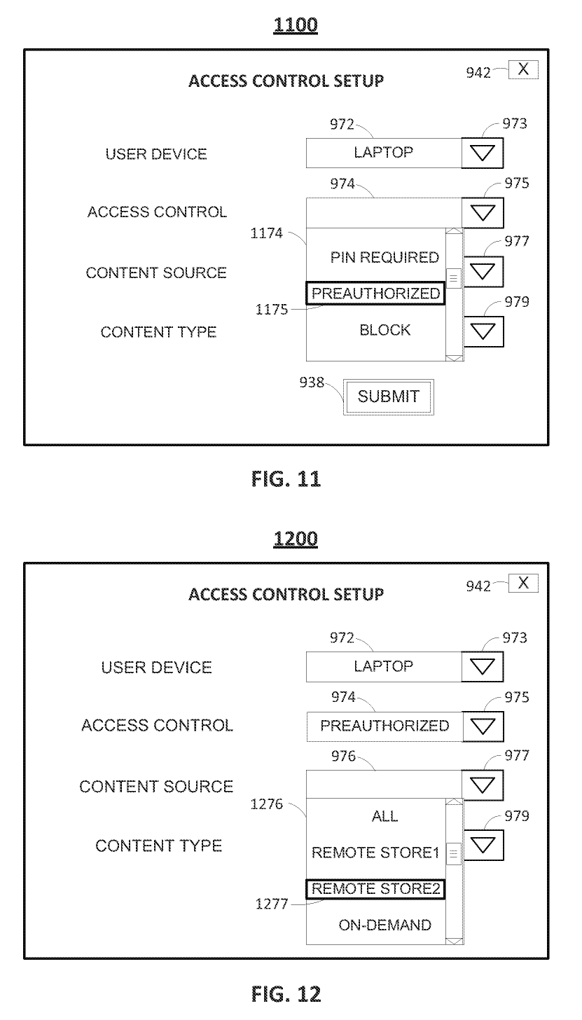

Next, in response to the user actuating list icon 975, control circuitry 304 may cause drop down menu region 1174 to be displayed with a listing of available access control options, as shown in FIG. 11. The available access control options may be PIN REQUIRED, PREAUTHORIZED, and BLOCK, and/or any other suitable option(s). In some embodiments, the PIN REQUIRED option may require a user to enter a PIN from the user device selected in list region 972 when that device is used to access specified types of content or content from specified sources, as selected from list regions 976 and 978. For example, a PIN may be required when using the laptop selected in list region 972 to access content from one of the remote storage providers 516. In some embodiments, a password may be required instead of a PIN. In some embodiments, the PREAUTHORIZED option may allow a user to access content with the user device specified in list region 972 for the sources and types of content specified in list regions 976 and 978 without having to enter a PIN and/or any other access authorization. For example, a user may instruct media guidance system 400 to allow the user's smart phone to be used to access any content from any source. In some embodiments, the BLOCK option may prevent access via the device selected in list region 972 to content sources and types of content selected in list regions 976 and 978. For example, a user may block the laptop specified in list region 972 from accessing, for example, R-rated content and/or content from, for example, one of remote storage providers 516. As indicated in FIG. 11, the user may select the PREAUTHORIZED access control option using highlight indicator 1175 and user input interface 310.

Then, in response to the user actuating icon 977, control circuitry 304 may cause drop down menu region 1276 to be displayed with a listing of available content sources, as shown in FIG. 12. This listing may be retrieved by control circuitry 304 from storage 308 or from media guidance data source 418, and may include any or all of the content sources described above in connection with FIGS. 1-5, including cloud-based content sources, such as remote storage providers 516 (FIG. 5). In some embodiments, the content sources listed in menu region 1276 may also include an option of ALL, which may allow a user to apply the same access controls to all sources of content available to the selected user device. As indicated in FIG. 12, for example, the user may select the REMOTE STORE2 content source option using highlight indicator 1277 and user input interface 310.

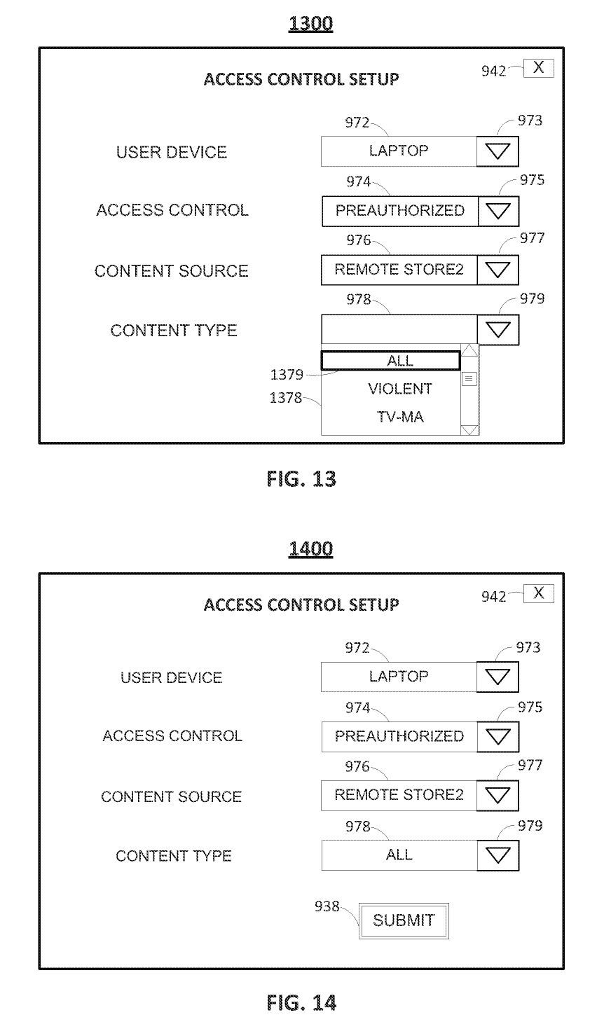

In response to the user actuating list icon 979, control circuitry 304 may next cause drop down menu region 1378 to be displayed with a listing of content types, as shown in FIG. 13. The content types listed may include parental or movie type ratings by which at least some content is rated. For example, the content types listed in menu region 1378 may include, for example, TV-type ratings such as “TV-7” (for children age 7) through “TV-MA” (for mature audiences). The selectable options listing may additionally or alternatively include movie-style ratings such as, for example, PG, PG-13, R, and NC-17. The selectable options listing may additionally or alternatively include more descriptive identifiers such as, for example, VIOLENT and/or PROFANITY. Any suitable options by which content may be rated or typed may be listed in menu region 1378. Content types listed in menu region 1378 may be listed in an order relating to how objectionable the content may be. For example, if a user selects a PG-13 content type, control circuitry 304 may apply the access control settings to other content having ratings listed higher in the order than PG-13, such as, for example, content having an R or NC-17 rating. Returning to FIG. 13, the user may select, for example, the ALL content type option, using highlight indicator 1379 and user input interface 310. The ALL content type option may be used to indicate that the options selected in list regions 972, 974, and 976 apply to all content types.

In response to these user selections, control circuitry 304 may cause the selections of LAPTOP, PREAUTHORIZED, REMOTE STORE2, and ALL to appear in list regions 972, 974, 976, and 978, respectively, as shown in FIG. 14. In sum, the user's selections may indicate the following: the user's laptop is preauthorized to access all content from a second remote storage provider.

The user may then submit these access control instructions to control circuitry 304 by actuating a SUBMIT button 938 with user input interface 310.

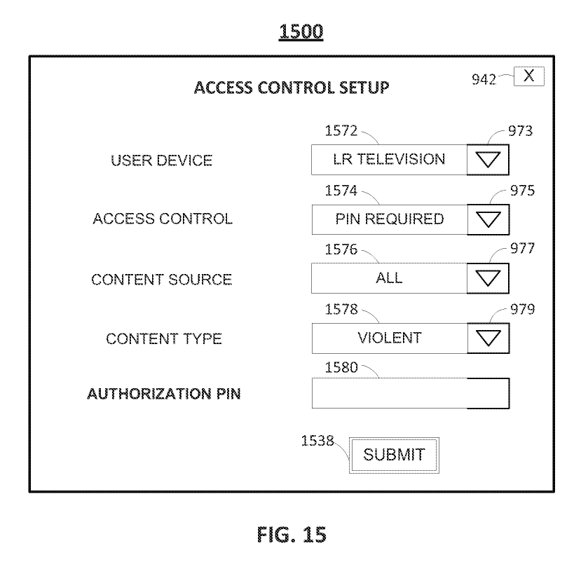

In cases where the “PIN REQUIRED” option is submitted for a user device, control circuitry 304 may respond by generating and transmitting display screen 1500, shown in FIG. 15, to display 312. Display screen 1500 may be used to request the user to enter a PIN (or, alternatively in other embodiments, a password) to be used with the selected device when that device is used to access the selected content sources and/or content types for that device. For example, as shown in display 1500 (FIG. 15), a user may have previously selected a living room television as indicated in user device list region 1572, a PIN REQUIRED level of access control as indicated at list region 1574, an ALL selection as indicated at content source list region 1576, and a content type of VIOLENT as indicated at list region 1578. The user may enter a PIN in field 1580 that may need to be submitted from the living room television (e.g., with a user input interface 310 such as a remote control) in order to access violent content using that television. After entering the PIN, the user may actuate submit button 1538 to submit the selected access control instructions to control circuitry 304. In some embodiments, the PIN (or password) may be required to be different than the access control code required to enter display screen 900.

Control circuitry 304, or media guidance data source 418, depending on the implementation of the media guidance application as described above in connection with FIGS. 4 and 5, may process subsequently received access control settings as follows: (1) Any subsequently submitted access control settings that do not conflict with previously submitted access control settings may be added to the user's profile and applied to subsequent requests for content by control circuitry 304. (2) Any subsequently submitted access control settings that conflict with previously submitted settings may cause control circuitry 304 to override the previously submitted settings and apply the subsequently submitted settings to requests for content.

For example, control circuitry 304 may apply a first received access control setting that may preauthorize user equipment device 300 to receive certain content. A subsequent access control setting received by control circuitry 304 may block user equipment device 300 from receiving that same certain content. In response, control circuitry 304 may override the first access control setting and apply the second access control setting by blocking access to that certain content. In some cases, conflicting access control settings may be received simultaneously by control circuitry 304 for a same user equipment device 300. This may occur, for example, when one access control setting is received from one user equipment device (e.g., a parent's smart phone) and another access control setting is received from another user equipment device (e.g., a child's smart phone, the child having obtained the access control code to the parent's media guidance application account). Control circuitry 304 may respond as follows: (1) reject both settings; (2) apply the more restrictive access control setting (e.g., to thwart a child's attempt to circumvent a parent's desired setting); or (3) apply the setting from whichever user equipment device has a higher priority as may have been predetermined when the user identified his or her user equipment devices to the media guidance application. Thus, in the example of the parent and child, the parent may have identified the parent's smart phone as having the highest priority and, thus, the setting received from the parent's smart phone will be applied.

The parental control feature of the invention may be applied with a wide range of user access control settings, as illustrated by the following. For example, by using display screens 900, 1000, 1100, 1200, 1300, 1400, and 1500 described above, a user may submit access control settings to control circuitry 304 to indicate that the user's mobile telephone 406 is preauthorized to receive (e.g., view or download) any content requested from the mobile telephone. Also, the user may indicate that the mobile telephone is preauthorized to receive only certain specified user content. User content may include movies, television programs, electronic books, games, music, photographs, video recordings, audio recordings, and/or any other suitable content. In another case, the user may indicate that the mobile telephone is preauthorized to receive only content from one or more specified content sources.

Control circuitry 304 may receive and apply access control settings from a user indicating that another device, such as, for example, television equipment 402, located in the user's family room, is blocked from receiving certain kinds of content and/or content from a particular source. Control circuitry 304 may deny any request for those certain kinds of content and/or content from that particular source requested from television equipment 402.

Control circuitry 304 may receive and apply access control settings from a user indicating that still another device, for example, a wireless video player 406, which may be used by the user's older children, requires user access authorization in order to receive certain content or content from a specified source. This prevents the video player from being able to receive content that the older children may attempt to receive with the video player.

Control circuitry 304 may also receive and apply access control settings from a user indicating that (1) certain content, and/or (2) any content from a particular source, and/or (3) certain content from a particular source requires user access authorization, regardless of which of the user's equipment devices 300 is used. In response to receiving and applying these access control settings, control circuitry 304 may accordingly override and replace any previously received user access control settings preauthorizing a user equipment device 300 to receive any of the content identified in the most recently received user access control settings.

Control circuitry 304 may receive and apply access control settings from a user that apply to the user equipment device 300 that includes control circuitry 304, or that apply to one or more other of the user's equipment devices 300. User equipment devices 300 may include, for example, a personal computer, a hand-held computer, a set-top box, a streaming media player, a television, a DVD player, a mobile telephone, and/or any other suitable device.

Control circuitry 304 may receive and apply access control settings from a user indicating that all or certain content from all or certain content sources require user access authorization, regardless of from which user equipment device the request for that content is made. For example, control circuitry 304 may receive access control settings indicating that certain pieces of content from a remote storage provider require user access authorization. In another example, control circuitry 304 may receive and apply user access control settings indicating that any content from a certain content source requires user access authorization.

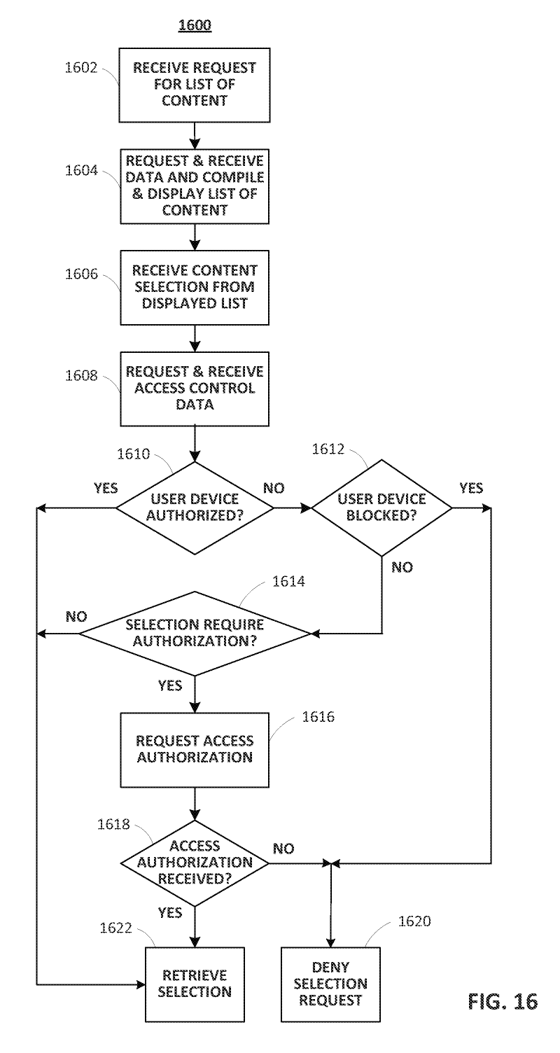

Turning to FIG. 16, an illustrative flow diagram 1600 of a process for providing parental controls (access controls) in a cloud-based media guidance application that may be performed by control circuitry 304 in accordance with some embodiments of the invention is shown. As illustrated, at step 1602, control circuitry 304 may receive a user request from a certain user equipment device 310 for a listing of content that may be located at one or more content sources. The content sources may be local or remote, such as, for example, one or more of remote storage providers 516 and/or media content sources 416. Such a request may be generated by the user using display 700 of FIG. 7.

In response to receiving the user request, at step 1604, control circuitry 304 may request content data from the one or more content sources. In response to receiving the data, control circuitry 304 may compile a list of content, generate a display of that list of content, and transmit the display to display 312. In some embodiments, the list of content may be displayed in a display similar or identical to, for example, display 100, display 200, and/or display 800, in a display similar to a combination of two or more of display 100, display 200, and display 800, or in any other suitable display.

At step 1606, control circuitry 304 may receive from user input interface 310 a request for content selected from the display of the list of content on display 312. Such a request may be made as described above in connection with FIGS. 1, 2, and 8, or in any suitable manner.

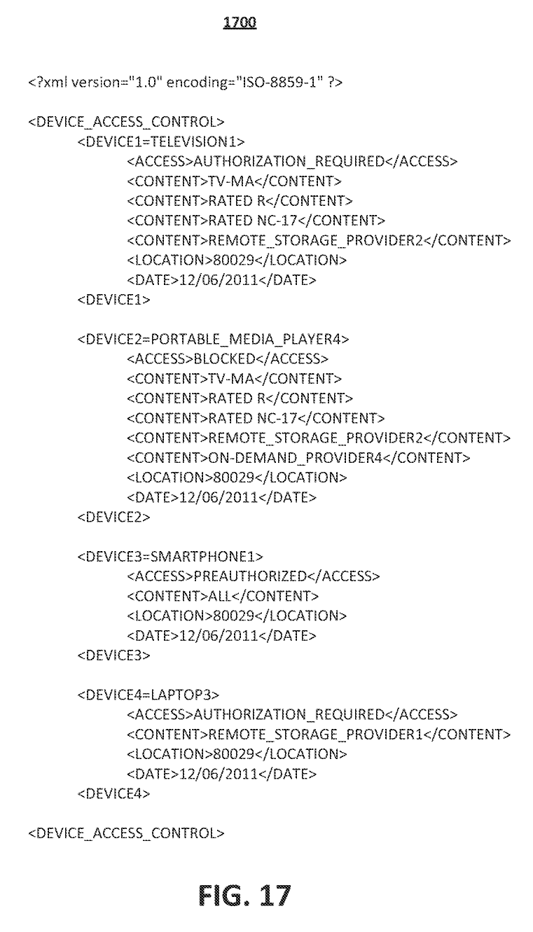

At step 1608, control circuitry 304 may request and receive access control data from storage 308, media guidance data source 418, and/or any other suitable location. Any suitable mechanism for requesting and receiving access control data may be used. For example, in some embodiments, control circuitry 304 may transmit a query to storage 308 or media guidance data source 418 for access control settings that may have been previously submitted by a user for user equipment device 300, as described in connection with FIGS. 9-15. In response to the query, control circuitry 304 may receive the requested access control settings in an XML structure, such as, for example, an XML structure 1700 as illustrated in FIG. 17. In some embodiments, control circuitry 304 may receive the user's profile, or data from the user's profile, that may contain access control information in response to the query.

At step 1610, control circuitry 304 may determine whether the user equipment device 300 is preauthorized to access the requested content based on the received access control data. In some embodiments, control circuitry 304 may use the information received in XML structure 1700 of FIG. 17 to make this determination. For example, control circuitry 304 may determine that user equipment device 300 is DEVICE3 based on information that may be received in step 1602. Control circuitry 304 may then determine from XML structure 1700 that DEVICE3, which is the user's smart phone, has an ACCESS setting of PREAUTHORIZED, as shown in FIG. 17. In some embodiments where the user's profile or data from the user's profile is received, as described above in connection with step 1608, control circuitry 304 may use access control information from the user's profile to determine whether user equipment device 300 is preauthorized to access the requested content. If it is determined that user equipment 300 is preauthorized to access the requested data, process 1600 may proceed to step 1622, described below. Otherwise, process 1600 may proceed to step 1612.

At step 1612, control circuitry 304 may determine whether user equipment device 300 is blocked from accessing the requested content. In some embodiments, the information received in XML structure 1700 may be used by control circuitry 304 to make this determination. For example, control circuitry 304 may determine that user equipment device 300 is DEVICE2 based on information that may be received in step 1602. Control circuitry 304 may then determine from XML structure 1700 that DEVICE2, which is a portable media player, has an ACCESS setting of BLOCKED for certain types of content (e.g., TV-MA, RATED R, and RATED NC-17) and for content from a certain content provider (e.g., REMOTE STORAGE PROVIDER2), as shown in FIG. 17. In some embodiments where the user's profile or data from the user's profile is received, as described above in connection with step 1608, control circuitry 304 may use access control information from the user's profile to make the determination of whether user equipment device 300 is blocked from accessing the requested content. If it is determined that user equipment device 300 is blocked from accessing the requested content, process 1600 may proceed to step 1620. Otherwise, process 1600 may proceed to step 1614.

At step 1614, control circuitry 304 may determine whether the selected content or the source that may provide the selected content, requires user access authorization when accessed from user equipment device 300. In some embodiments, control circuitry 304 may use the information received in XML structure 1700 to make this determination. For example, control circuitry 304 may determine that user equipment device 300 is DEVICE4 based on information that may be received in step 1602. Control circuitry 304 may then determine from XML structure 1700 that DEVICE4, which is a laptop computer, has an ACCESS setting of AUTHORIZATION REQUIRED for content from a certain content provider (e.g., REMOTE STORAGE PROVIDER1), as shown in FIG. 17. In some embodiments where the user's profile or data from the user's profile is received, as described above in connection with step 1608, the received access control information from the user's profile may be used by control circuitry 304 to make the determination of whether user access authorization is required to access the requested content. If control circuitry 304 determines that user access authorization is not required to access the requested content with user equipment device 300, process 1600 may proceed to step 1622. Otherwise, process 1600 may proceed to step 1616.

At step 1616, control circuitry 304 may generate and transmit to display 312 a request for the user to enter the required user access authorization. Any suitable display may be used at display 312 to indicate to the user that access authorization is required in order to access the requested content. For example, control circuitry 304 may generate and display a screen similar to display 1500 that identifies the content the user is attempting to access and requesting a PIN or password to be entered to access the content.

At step 1618, control circuitry 304 may determine whether the required user access authorization has been received. If the required user access authorization has not been received (e.g., either the wrong access authorization has been received more than a predetermined number of times, or no access authorization has been received within a predetermined time limit), process 1600 may proceed to step 1620. Otherwise, process 1600 may proceed to step 1622. For example, control circuitry 304 may determine whether the PIN or password entered in display 1500 matches the PIN or password previously established for accessing the selected content (e.g., the PIN or password set up using display 1500).

At step 1620, control circuitry 304 may generate and transmit to display 312 a notification that the request for the selected content is denied. Control circuitry 304 may indicate in the notification whether the denial is based on the user equipment device 300 being blocked from receiving the requested content (pursuant to step 1612) or on the required user access authorization not being received at step 1618.

At step 1622, control circuitry 304 may retrieve the requested content. This may occur when either user equipment device 300 is preauthorized to access the requested content (as determined at step 1610), when user equipment device 300 does not require user access authorization (as determined at step 1614), or when control circuitry 304 determines that it received the required user access authorization at step 1618. As described above in connection with FIGS. 4 and 5, control circuitry 304 may communicate with the appropriate resources to retrieve the requested content, which may reside with a media content source 416, a remote storage provider 516, storage 308, or any other suitable database or content source, as described above. In response to establishing communication with the appropriate content source, control circuitry 304 may receive the requested content in any suitable manner (streaming, downloading, etc.). In response to receiving the requested content, control circuitry 304 may transmit the received content to display 312.

Note that in some embodiments, control circuitry 304 may determine at step 1604 whether any particular content, any type of content, and/or content from any particular source(s) is blocked from being accessed by user equipment device 300. Control circuitry 304 may make this determination based on receiving access control data with the content data received at step 1604. If control circuitry 304 determines that the received content listing data contains content that the user equipment device 300 is blocked from accessing, control circuitry may prevent that content from being listed in any generated display transmitted to display 312. In some of these embodiments, steps 1608 and 1612 may be omitted from process 1600 and the NO branch of step 1610 may go to step 1614.

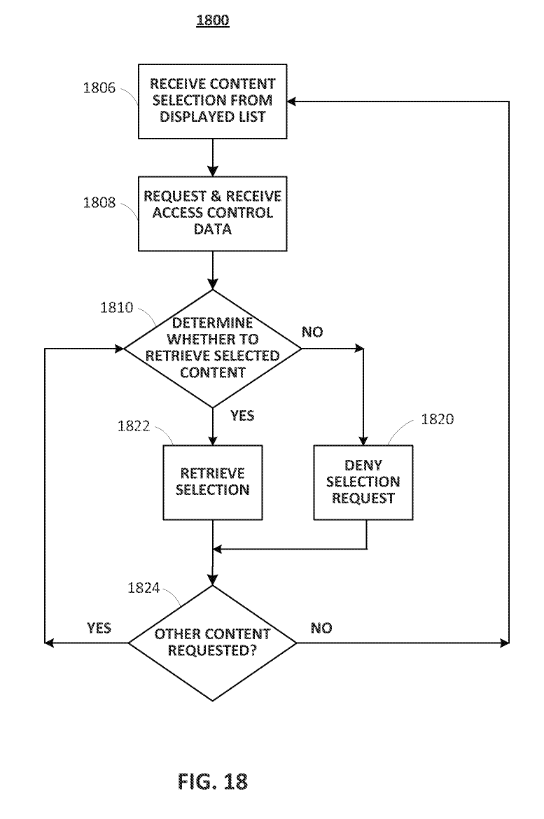

FIG. 18 shows an illustrative flow diagram 1800 of a process for providing parental controls (access controls) in a cloud-based media guidance application that may be performed by control circuitry 304 in accordance with some embodiments of the invention. Process 1800 may be performed by control circuitry 304 in cases where a user submits a request for multiple pieces of content from multiple remote storage providers.

At step 1806, control circuitry 304 may receive from user input interface 310 a request for content selected from a list of content displayed on display 312. Control circuitry 304 may generate the displayed list of content as described above in connection with steps 1602 and 1604 of process 1600, or in any suitable manner. The request for content may be made by the user as described above in connection with FIGS. 1, 2, and 8, or in any suitable manner, and such a request may contain selections for one or more pieces of content from one or more sources of content. Control circuitry 304 may perform step 1806 in a manner similar to that of step 1606 of process 1600.

At step 1808, control circuitry 304 may request and receive access control data from storage 308, media guidance data source 418, and/or any other suitable location. Any suitable mechanism for requesting and receiving access control data may be used. For example, in some embodiments, control circuitry 304 may transmit a query to storage 308 or media guidance data source 418 for access control settings that may have been previously submitted by a user for user equipment device 300, as described in connection with FIGS. 9-15. In response to the query, control circuitry 304 may receive the requested access control settings in an XML structure, such as, for example, the XML structure illustrated in FIG. 17. In some embodiments, control circuitry 304 may receive the user's profile or data from the user's profile that may contain access control information. Control circuitry 304 may perform this step in a manner similar to that of step 1608 of process 1600.

At step 1810, control circuitry 304 may determine whether to retrieve selected content based on the user's access control information. In cases where the user submits a request for several pieces of content, such as, for example, by checking two or more boxes 860, 862, and/or 864 next to desired content in content list regions 854, 856, and/or 858, respectively, and then actuating SUBMIT button 838 on screen 800 (FIG. 8), control circuitry 304 may retrieve each piece of selected content sequentially as determined by either the order in which the selected content is listed, and/or by content source order (e.g., referring to FIG. 8, retrieving content from REMOTE STORAGE PROVIDER #1 first, then content from REMOTE STORAGE PROVIDER #2, and lastly content from REMOTE STORAGE #3), and/or in any other suitable manner.

Continuing at step 1810, control circuitry 304 may first determine whether user equipment device 300 is preauthorized to access the requested content based on the received access control data. Control circuitry 304 may perform this determination in a manner similar or identical to that of step 1610 of process 1600. If control circuitry 304 determines that user equipment device 300 is preauthorized, process 1800 may proceed to step 1822. Otherwise, control circuitry 304 may next determine whether user equipment device 300 is blocked from accessing the requested content. Control circuitry 304 may perform this determination in a manner similar or identical to that of step 1612 of process 1600. If it is determined that equipment device 300 is blocked from accessing the requested content, process 1800 may proceed to step 1820, described below. If it is determined that equipment device 300 is not blocked, control circuitry 304 may next determine whether the selected content or the source that may provide the selected content, requires user access authorization when accessed from user equipment device 300. Control circuitry 304 may perform this determination in a manner similar or identical to that of step 1614 of process 1600. If control circuitry 304 determines that user access authorization is not required to access the requested content with equipment device 300, process 1800 may proceed to step 1822. Otherwise, control circuitry 304 may generate and transmit to display 312 a request for the user to enter the required user access authorization. Any suitable display may be used at display 312 to indicate to the user that access authorization is required in order to access the requested content. Control circuitry 304 may perform the display generation function in a manner similar or identical to that of step 1616 of process 1600. If the required user access authorization is not received (e.g., either the wrong access authorization has been received more than a predetermined number of times, or no access authorization is received within a predetermined time limit), process 1800 may proceed to step 1820. Otherwise, process 1800 may proceed to step 1822.

At step 1820, control circuitry 304 may generate and transmit to display 312 a notification that the request for the selected content is denied. Control circuitry 304 may indicate in the notification whether the denial is based on user equipment device 300 being blocked from receiving the requested content or on the required user access authorization not being received. Control circuitry 304 may perform this step in a manner similar to that of step 1620 of process 1600.

At step 1822, control circuitry 304 may retrieve the requested content. This may occur when either user equipment device 300 is preauthorized to access the requested content, when user equipment device 300 does not require user access authorization, or when control circuitry 304 determines that it received the required user access authorization. As described above in connection with FIGS. 4 and 5, control circuitry 304 may communicate with the appropriate resources to retrieve the requested content, which may reside with a media content source 416, a remote storage provider 516, storage 308, or any other suitable database or content source, as described above. In response to establishing communication with the appropriate content source, control circuitry 304 may receive the requested content in any suitable manner (streaming, downloading, etc.). In response to receiving the requested content, control circuitry 304 may transmit the received content to display 312. Control circuitry 304 may perform this step in a manner similar to that of step 1622 of process 1600.

At step 1824, control circuitry 304 may determine whether one or more other pieces of content included in the user's request for selected content remain to be retrieved, subject to the received access control data. If it is determined that one or more other pieces of requested content remain to be retrieved, process 1800 may return to step 1810. Otherwise, process 1800 may return to step 1806 to await another request for selected content from the user.

It should be understood that the above steps of the flow diagrams of FIGS. 16 and 18 may be executed or performed in any order or sequence not limited to the order and sequence shown and described in the figures. Also, some of the above steps of the flow diagrams of FIGS. 16 and 18 may be executed or performed substantially simultaneously where appropriate or in parallel to reduce latency and processing times.

Although steps 1610, 1612, 1614, 1616, and 1618 of FIG. 16, and step 1810 of FIG. 18, are described herein as being performed by control circuitry 304 of a user equipment device, in some embodiments, some or all of these steps may be additionally or alternatively performed in another device. For example, some of these steps may be performed in media guidance data source 418, media content source 416, a provider 516, and/or any other suitable device.

It should be noted that, although the embodiments described herein generally refer to on-demand media assets and non-on-demand media assets, this is merely illustrative. For example, the control circuitry may divide the guidance display to present media guidance application listings between linear programming (e.g., broadcast listings) and non-linear programming (e.g., on-demand listings, recorded media listings, Internet content listings, etc.).

In some embodiments, any suitable computer readable media can be used for storing instructions for performing the processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

One skilled in the art will appreciate that the invention can be practiced by other than the described embodiments, which are presented for purposes of illustration and not of limitation, and the invention is limited only by the following claims.

What is claimed is:

1. A method of controlling access to user content, the method comprising:
receiving, at a hardware processor from a user device, a user request to receive a listing of user content stored with a plurality of remote content storage providers;
compiling a listing of the user content;
receiving, at the hardware processor from the user device, a user selection of one of the user content listed in the listing as selected content;
in response to receiving the user selection, determining whether the selected content requires access authorization; and
in response to (1) determining that the selected content does not require access authorization, or (2) receiving access authorization from the user device:
determining from which one of the plurality of remote content storage providers to retrieve the selected content, and
instructing the one of the plurality of remote content storage providers to send the selected content to the user device.

2. The method of claim 1, further comprising:
in response to determining that the selected content requires access authorization, determining whether the user device is pre-authorized to receive the selected content;
in response to determining that the user device is not pre-authorized to receive the selected content, requesting the user to enter user access authorization and receiving the user access authorization; and
in response to determining that the user device is pre-authorized to receive the selected content, performing (1) the determining from which one of the plurality of remote content storage providers to retrieve the selected content and (2) the instructing.

3. The method of claim 1, wherein the user content comprises at least one of movies, television programs, electronic books, games, music, photographs, video recordings, and audio recordings.

4. The method of claim 1, wherein the user device comprises one of a personal computer, a hand-held computer, a set-top box, a streaming media player, a television, a DVD player, and a mobile telephone.

5. The method of claim 1, wherein the user access authorization comprises a password or a personal identification number.

6. The method of claim 1, further comprising:
receiving a user indication identifying one of a plurality of user devices as being pre-authorized to receive one of the user content; and
in response to receiving the user indication, preventing sending of the one of the user content to another of the plurality of user devices unless user access authorization is received.

7. The method of claim 1, further comprising:
receiving a user indication identifying one of the plurality of remote content storage providers with which a portion of the user content is stored as requiring user access authorization to send to the user device any of the portion of the user content; and
in response to receiving the user indication, preventing sending of any of the portion of the user content to the user device unless the user access authorization is received.

8. The method of claim 1, further comprising:
receiving a first user indication identifying the user device as being authorized to receive user content stored with only one of the plurality of remote content storage providers; and
in response to receiving the first user indication, preventing sending of any of the user content not stored with the one of the plurality of remote content storage providers to the user device.

9. The method of claim 8, further comprising:
receiving a second user indication indicating that user access authorization is required from the user device to receive the user content stored with the one of the plurality of remote content storage providers; and
in response to receiving the second user indication, preventing sending of any of the user content stored with the one of the plurality of remote content storage providers to the user device unless user access authorization is received.

10. The method of claim 1, further comprising:
receiving a user indication identifying the user device as not being authorized to receive any user content stored with one of the plurality of remote content storage providers; and
in response to receiving the user indication, preventing sending of any of the user content stored with the one of the plurality of remote content storage providers to the user device.

11. A system for controlling access to user content, the system comprising:
processing circuitry configured to:
receive from a user device a user request to receive a listing of user content stored with a plurality of remote content storage providers;
compile a listing of the user content;
receive from the user device a user selection of one of the user content listed in the listing as selected content;
in response to receiving the user selection, determine whether the selected content requires access authorization; and
in response to (1) determining that the selected content does not require access authorization, or (2) receiving access authorization from the user device:
determine from which one of the plurality of remote content storage providers to retrieve the selected content, and
instruct the one of the plurality of remote content storage providers to send the selected content to the user device.

12. The system of claim 11, wherein the processing circuitry is further configured to:
in response to determining that the selected content requires access authorization, determine whether the user device is pre-authorized to receive the selected content;
in response to determining that the user device is not pre-authorized to receive the selected content, request the user to enter user access authorization and receiving the user access authorization; and
in response to determining that the user device is pre-authorized to receive the selected content, perform (1) the determine from which one of the plurality of remote content storage providers to retrieve the selected content and (2) the instruct.

13. The system of claim 11, wherein the user content comprises at least one of movies, television programs, electronic books, games, music, photographs, video recordings, and audio recordings.

14. The system of claim 11, wherein the user device comprises one of a personal computer, a hand-held computer, a set-top box, a streaming media player, a television, a DVD player, and a mobile telephone.

15. The system of claim 11, wherein the user access authorization comprises a password or a personal identification number.

16. The system of claim 11, wherein the processing circuitry is further configured to:
receive a user indication identifying one of a plurality of user devices as being pre-authorized to receive one of the user content; and
in response to receiving the user indication, prevent sending of the one of the user content to another of the plurality of user devices unless user access authorization is received.

17. The system of claim 11, wherein the processing circuitry is further configured to:
receive a user indication identifying one of the plurality of remote content storage providers with which a portion of the user content is stored as requiring user access authorization to send to the user device any of the portion of the user content; and
in response to receiving the user indication, prevent sending of any of the portion of the user content to the user device unless the user access authorization is received.

18. The system of claim 11, wherein the processing circuitry is further configured to:
receive a first user indication identifying the user device as being authorized to receive user content stored with only one of the plurality of remote content storage providers; and
in response to receiving the first user indication, prevent sending of any of the user content not stored with the one of the plurality of remote content storage providers to the user device.

19. The method of claim 8, wherein the processing circuitry is further configured to:
receive a second user indication indicating that user access authorization is required from the user device to receive the user content stored with the one of the plurality of remote content storage providers; and
in response to receiving the second user indication, prevent sending of any of the user content stored with the one of the plurality of remote content storage providers to the user device unless user access authorization is received.

20. The system of claim 11, wherein the processing circuitry is further configured to:
receive a user indication identifying the user device as not being authorized to receive any user content stored with one of the plurality of remote content storage providers; and
in response to receiving the user indication, prevent sending of any of the user content stored with the one of the plurality of remote content storage providers to the user device.

21. Apparatus for controlling access to user content, the apparatus comprising:
means for receiving from a user device, a user request to receive a listing of user content stored with a plurality of remote content storage providers;
means for compiling a listing of the user content;
means for receiving from the user device, a user selection of one of the user content listed in the listing as selected content;
in response to receiving the user selection, means for determining whether the selected content requires access authorization; and
in response to (1) determining that the selected content does not require access authorization, or (2) receiving access authorization from the user device:
means for determining from which one of the plurality of remote content storage providers to retrieve the selected content, and
means for instructing the one of the plurality of remote content storage providers to send the selected content to the user device.

22. The apparatus of claim 21, further comprising:
in response to determining that the selected content requires access authorization, means for determining whether the user device is pre-authorized to receive the selected content;
in response to determining that the user device is not pre-authorized to receive the selected content, means for requesting the user to enter user access authorization and means for receiving the user access authorization; and
in response to determining that the user device is pre-authorized to receive the selected content, means for performing (1) the determining from which one of the plurality of remote content storage providers to retrieve the selected content and (2) the instructing.

23. The apparatus of claim 21, wherein the user content comprises at least one of movies, television programs, electronic books, games, music, photographs, video recordings, and audio recordings.

24. The apparatus of claim 21, wherein the user device comprises one of a personal computer, a hand-held computer, a set-top box, a streaming media player, a television, a DVD player, and a mobile telephone.

25. The apparatus of claim 21, wherein the user access authorization comprises a password or a personal identification number.

26. The apparatus of claim 21, further comprising:
means for receiving a user indication identifying one of a plurality of user devices as being pre-authorized to receive one of the user content; and
in response to receiving the user indication, means for preventing sending of the one of the user content to another of the plurality of user devices unless user access authorization is received.

27. The apparatus of claim 21, further comprising:
means for receiving a user indication identifying one of the plurality of remote content storage providers with which a portion of the user content is stored as requiring user access authorization to send to the user device any of the portion of the user content; and
in response to receiving the user indication, means for preventing sending of any of the portion of the user content to the user device unless the user access authorization is received.

28. The apparatus of claim 21, further comprising:
means for receiving a first user indication identifying the user device as being authorized to receive user content stored with only one of the plurality of remote content storage providers; and
in response to receiving the first user indication, means for preventing sending of any of the user content not stored with the one of the plurality of remote content storage providers to the user device.

29. The apparatus of claim 28, further comprising:
means for receiving a second user indication indicating that user access authorization is required from the user device to receive the user content stored with the one of the plurality of remote content storage providers; and
in response to receiving the second user indication, means for preventing sending of any of the user content stored with the one of the plurality of remote content storage providers to the user device unless user access authorization is received.

30. The apparatus of claim 21, further comprising:
means for receiving a user indication identifying the user device as not being authorized to receive any user content stored with one of the plurality of remote content storage providers; and
in response to receiving the user indication, means for preventing sending of any of the user content stored with the one of the plurality of remote content storage providers to the user device.
